(19) United States
(12) Patent Application Publication
(10) Pub. No.: US 2026/0313297 A1
(43) Pub. Date: Oct. 8, 2026

(54) THIN BALANCED ARMATURE RECEIVER

(71) Applicant: KNOWLES ELECTRONICS, LLC, ITASCA, IL (US)

(72) Inventors: MOHAMMAD MOHAMMADI, ROLLING MEADOWS, IL (US); STEPHEN ROYS, WEST CHICAGO, IL (US); YAHUI ZHANG, SCHAUMBURG, IL (US); CHRISTOPHER MONTI, ELGIN, IL (US)

(21) Appl. No.: 19/170,826

(22) Filed: Apr. 4, 2025

(51) Int. Cl. H04R 11/02; H04R 1/02; H04R 7/04; H04R 7/18

(52) U.S. Cl. CPC H04R 11/02; H04R 1/025; H04R 7/04; H04R 7/18

(57) ABSTRACT

Various embodiments of balanced armature receivers are disclosed, where the receiver includes a housing having a sound port, a diaphragm separating an interior of the housing into a back volume and a front volume connected to the sound port, a yoke, disposed in the housing, retaining first and second permanent magnets in spaced-apart relation forming a gap, a coil having a coil tunnel, an armature having a fixed portion that extends through the coil tunnel, and a movable portion that extends outside the coil and comprising an end portion located in the gap between the magnets, and the diaphragm mounted on the movable portion of the armature and having a length that extends inside the gap and over at least a portion of the coil.

### TECHNICAL FIELD

This disclosure relates generally to acoustic receivers and more specifically to balanced armature receivers (BARs).

### BACKGROUND

Many hearing instruments such as hearing aids, earphones, and personal audio headsets, among other devices include one or more balanced armature receivers, also referred to herein as “acoustic receivers” or “receivers”. Such receivers generally comprise a case or housing containing a diaphragm that divides an interior of the housing into front and back volumes. A motor located in the back volume includes an electrical coil with a passage through which an armature (also called a reed) is disposed. The armature has a stationary end fixed to a yoke and another end movably disposed between magnets supported by the yoke. A drive rod or other link couples the armature to the diaphragm. In operation, an electrical signal applied to the electrical coil causes the armature to vibrate between the magnets. The vibrating armature moves the diaphragm, resulting in emission of sound from a sound port in the front volume of the housing.

Demands for smaller devices are increasing with the advent of more capability requirements, focus on reduced cost, more stringent vibration requirements and changing form factors, among other criteria. For example, external forces or shocks that are applied to the receiver may damage the internal components such as the armature, thereby reducing performance of the receiver. Larger balanced armature receivers, including dual balanced armature receivers can in some cases be more prone to vibration issues, can be too large and constrain device capabilities, can be costly and/or can limit device form factors. Some known BARs employ a thinner design configuration compared to other designs but such BARs may have small diaphragms and front volumes that can limit response characteristics of the BAR. Therefore, there is a need for smaller balanced armature receivers.

### BRIEF DESCRIPTION OF THE DRAWINGS

FIG. 1 is a perspective view of a balanced armature receiver according to some embodiments;

FIG. 2 is a side sectional view of the balanced armature receiver of FIG. 1 when cut and viewed along the line A – A;

FIG. 3 is a cross sectional view of the balanced armature receiver of FIG. 1 when cut along the line B – B;

FIG. 4 is a perspective view of the balanced armature receiver of FIG. 1, without a nozzle sleeve according to some embodiments;

FIG. 5 is a side sectional view of a balanced armature receiver along line C – C in FIG. 4;

FIG. 6 is an exploded view of the balanced armature receiver of FIG. 4;

FIG. 7 is a perspective view of a dual balanced armature receiver, according to some embodiments;

FIG. 8 is a side sectional view of the balanced armature receiver along line D – D in FIG. 7;

FIG. 9 is an expanded perspective view of the balanced armature receiver of FIG. 7;

FIG. 10 is a side sectional view of the balanced armature receiver arrangement shown in FIG. 9 along line E – E; and

FIG. 11 is an expanded side sectional view of a balanced armature receiver, according to an embodiment.

Those of ordinary skill in the art will appreciate that elements in the figures are illustrated for simplicity and clarity. It will be further appreciated that certain actions or steps may be described or depicted in a particular order of occurrence while those of ordinary skill in the art will understand that such specificity with respect to sequence is not actually required unless a particular order is specifically indicated. It will also be understood that the terms and expressions used herein have meanings accorded to such terms and expressions by those having ordinary skill in the art except where specific meanings have otherwise been set forth herein.

### DETAILED DESCRIPTION

The present disclosure pertains to balanced armature receivers (BARs) in one of numerous different implementations. Such receivers are typically integrated in hearing aids such as behind-the-ear (BTE) devices with a portion that extends into or on the ear, in-the-canal (ITC) or partially in the ear canal devices, receiver-in-canal (RIC) devices, as well as headsets, wired or wireless in-the-ear (ITE) earbuds or earpieces, among other devices that produce an acoustic output signal in response to an electrical input signal and intended are for use on, in, or in close proximity to a user’s ear.

In one implementation, a balanced armature receiver includes a housing having a sound port, a yoke disposed in the housing and retaining first and second permanent magnets in spaced-apart relation forming a gap. A diaphragm separates an interior of the housing into a front volume and a back volume. A coil is disposed in the front volume, having a coil tunnel. An armature includes a fixed portion that extends through the coil tunnel, and a movable portion that extends outside the coil and comprises an end portion located in the gap between the magnets. The end portion is free to deflect between the magnets in response to an excitation signal applied to the coil. The diaphragm is mounted on the movable portion of the armature and has a length that extends inside the gap and over at least a portion of the coil.

In some examples, a type of full length diaphragm is employed that is directly affixed with an adhesive to the movable portion of the diaphragm and is configured to have a longitudinal length that extends a full length of the coil and a full length of the first and second magnets. In certain implementations, the housing comprises a cup that comprises a first cup portion and a second cup portion coupled to the first portion, and the yoke comprises a first wall of the first cup portion and an opposing wall of the first cup portion. In some implementations, the front volume comprises the coil, the movable portion of the armature, the first magnet and the back volume comprises the second magnet.

In one implementation, a dual armature receiver includes multiple BARs that are arranged to share a front volume and each BAR is configured to include an armature having a fixed portion that extends through a respective coil tunnel, and a movable portion that extends outside a coil and an end portion located at in the gap between the magnets, wherein the end portion is free to deflect between the magnets in response to an excitation signal applied to the coil. Each respective diaphragm is mounted on a movable portion of a respective armature and each has a length that extends inside the gap of respective magnets and over at least a portion of a respective coil.

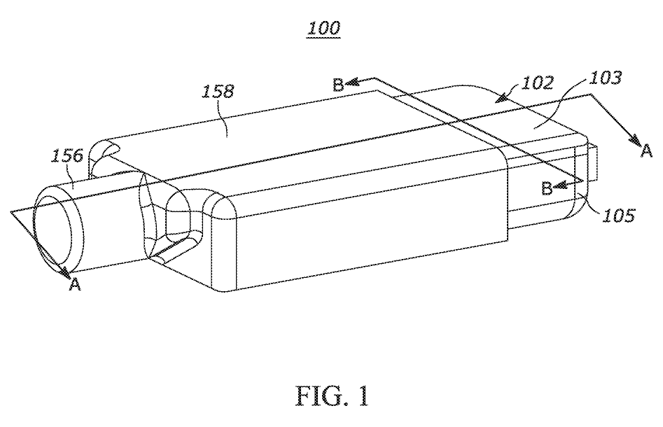

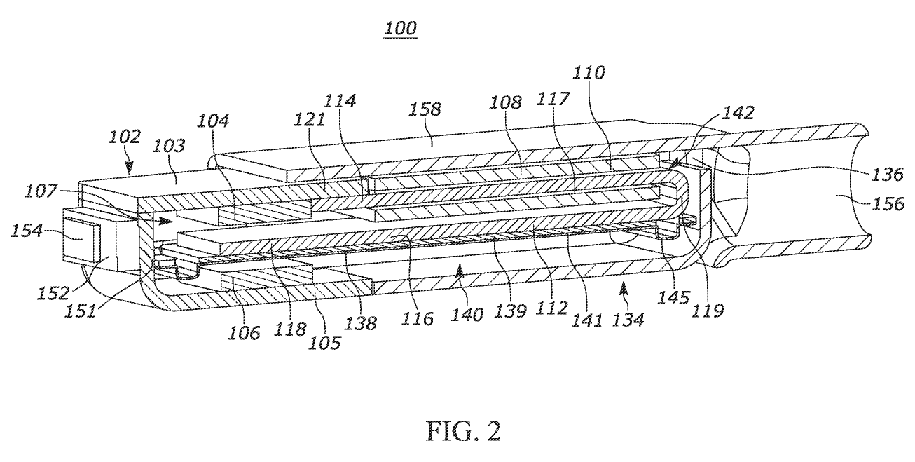

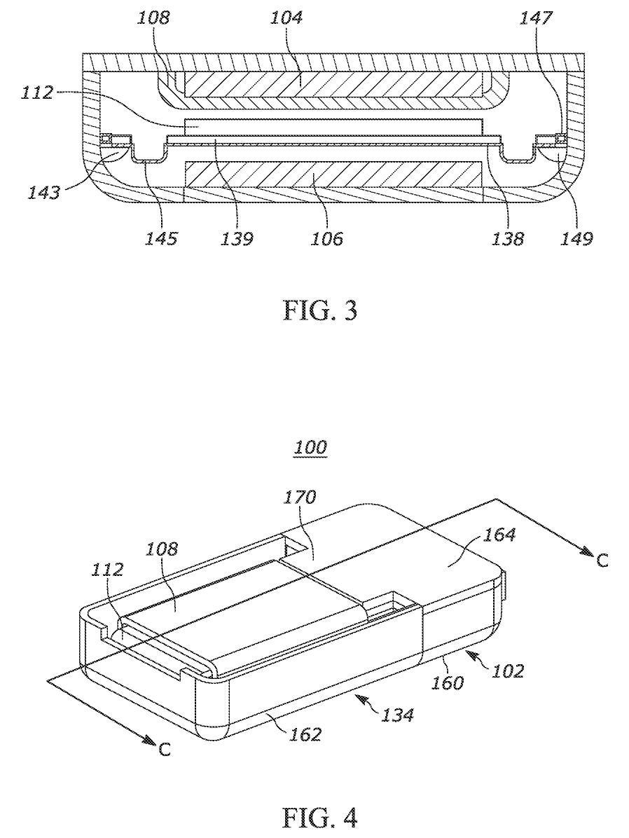

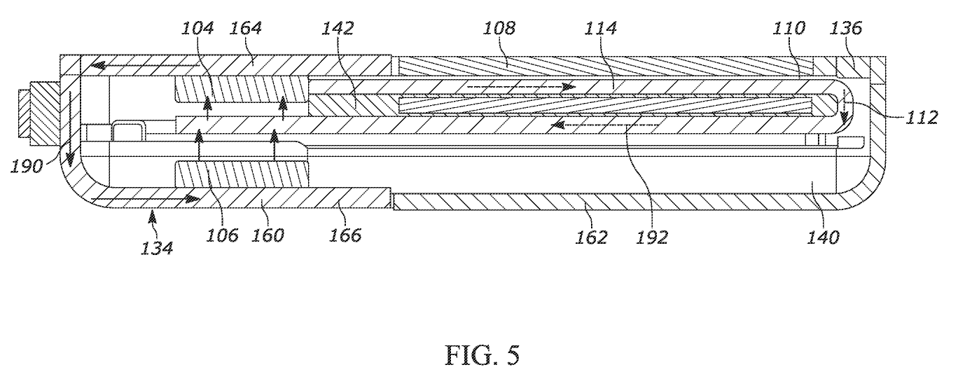

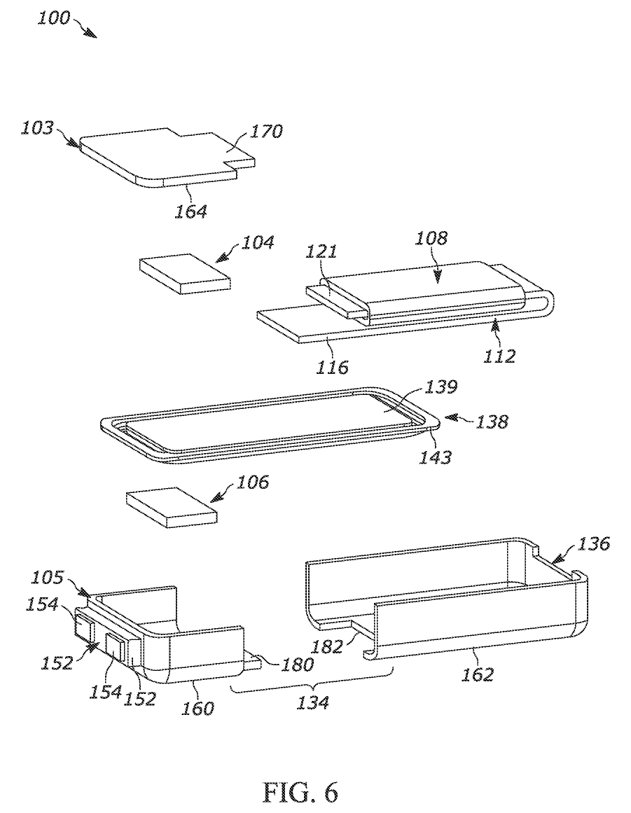

FIGS. 1-6 illustrate examples of a single acoustic receiver such as a balanced armature receiver 100 and FIGS. 7-11 illustrate examples of dual balanced armature receivers that combine to have a common front volume. FIG. 1 is a perspective view of a balanced armature receiver according to some embodiments; FIG. 2 is a side sectional view of the balanced armature receiver of FIG. 1 when cut and viewed along the line A – A; FIG. 3 is a cross sectional view of the balanced armature receiver of FIG. 1 when cut along the line B – B; FIG. 4 is a perspective view of the balanced armature receiver of FIG. 1, without a nozzle sleeve according to some embodiments; FIG. 5 is a side sectional view of a balanced armature receiver along line C – C in FIGS. 4 and 6 is an exploded view of the balanced armature receiver of FIG. 4.

As shown, a balanced armature receiver 100 has a yoke 102 with a yoke cover 103 retaining a first permanent magnet 104 and yoke housing portion 105 that retains a second permanent magnet 106 in spaced-apart relation forming a gap 107 between the magnets. The receiver also has a coil 108 (for example with an insulation material over coil windings) with a coil tunnel 110. As shown, in some implementations, the coil is closely fitted to the fixed portion of the armature. The receiver has an armature 112 or reed, for example that includes a bent strip of magnetic flux carrying material, with a fixed portion 114 of the armature coupled to the yoke and a movable portion 116 of the armature extending outside of the coil tunnel, as well as an end portion 118 located at least partially between the magnets in the gap 107. In one example, an adhesive 117 is applied between the coil tunnel and at least a portion of the armature that is located inside the coil tunnel. This adds stiffness to the armature movement and reduces the impact of unwanted mode shape. In conventional receivers there is no glue or limiter inside the coil tunnel. The end portion 118 of the armature is free to deflect between the magnets in response to an excitation signal applied to the coil 108.

In this example, the armature has a U-shaped portion 119 between the fixed portion 114 and the movable portion. In this example, the fixed portion is above and shorter than the lower movable portion 116 that is outside of the coil tunnel. However, any suitably shaped armature configuration may be employed. Also, in this example the width of the armature is constant for the length of the armature (the longitudinal direction along the length of the armature from an end of the housing having a sound port and an end that has electrical contacts accessible from an exterior of the housing). For example, the shorter and longer portions of the armature have the same width (in transverse direction) and thickness, however differing widths and thicknesses on the portions may also be employed. In this example, an end 121 of the fixed portion of the armature has an outer flat surface that is affixed, such as by epoxy, or welding etc., to an under surface of the yolk lid 103, adjacent to the magnet 104.

The receiver has a housing portion 134 (e.g., a metal or plastic casing) with a sound port 136. A diaphragm 138, which may include a movable paddle 139 and a flexible membrane 141, for example, separates an internal volume of the housing into a back volume 140 and a front volume 142. The diaphragm 138 is mounted on the movable portion 116 of the armature and has a length that extends inside the gap 107 and over at least a portion of the coil 108. The front volume is acoustically coupled with the sound port. The front volume 142 contains the coil 108, the armature 112, and the magnet 104. The back volume contains the magnet 106. The diaphragm 138 in this example is a type of full length diaphragm so that the front volume is large and has a longitudinal length that extends past a full length of the coil and past a full length of the magnet 104 and

In this example, the receiver diaphragm generally comprises a paddle 139 flexibly coupled to a frame 143 (see also FIG. 6) or ring and a suspension element 145 (also referred to herein as a "surround") covering a gap between the paddle and frame to provide an acoustic barrier between the front volume and the back volumes of the housing. In some implementations, an outer perimeter of the frame is attached to a side wall of the housing with glue 147 that bonds an interior surface of a wall of the housing and the frame. The housing such as a cup portion, includes stamped protrusions 149 that hold the frame. In this example, no stiff material connects the paddle to its frame so that its location is determined by the attachment to the armature. This type of “floating” configuration can avoid the use of hinges or other stiff material. The surround is typically made from a urethane, an elastomer or other suitable material. By having a “floating” configuration, the reed moves up and down (direction perpendicular to magnet), and can also move front to back (direction from sound slot to terminal tab). Hinges can restrict the front-back motion of the paddle. For example, the reed can move front-back but not the paddle. As a result, the paddle may peel off from the reed, then cause the receiver to lose function completely. Also, in some instances, the added hinge can over constrain the movement of paddle. However, it will be recognized that other configurations may also be employed.

An example of the motor includes the yoke 102, the coil 108, and the armature 112. The coil 108 comprises wound insulated wire.

Referring to FIGS. 4-6, the housing includes a cup that includes a first cup portion and a second cup portion affied to the first portion. Each cup portion has a base and upwardly projecting side walls from the base. The yoke comprises the yoke lid which serves as is a first wall 164 of the first cup portion and the yoke includes an opposing wall 166, such as a base, of the first cup portion. The first wall holds the magnet 104 and the second wall 166 holds the magnet 106. Each magnet is secured to respective yoke walls by an adhesive, welding or any suitable attachment mechanism. The yoke lid includes a flat projecting portion 170 or tab that overlaps and is affixed to the end of the fixed portion of the armature. The first cup portion and the second cup portions have surfaces that align to form a smooth outer surface for a bottom of the cup. For example, the yoke cup 160 base has projection tab 180 and cup portion 162 base has a corresponding cutout portion 182 that receives the tab 180. The cup portions are attached in one implementation by welding such as laser welding.

FIG. 5 also illustrates the magnetic circuit and shows DC flux flow from the magnets in solid arrows 190 in the yoke cup and AC flux flow in dashed arrows 192 in the armature when the coil is excited. In one implementation, the yoke cup that forms two sides of the yoke is made of magnetic flux conducting material that has high magnetic permeability and high saturation such as but not limited to nickel-iron alloy of approximately 49% nickel. In one implementation the other cup that houses the coil is made of non-magnetic flux conducting material that does not have a high magnetic permeability, such as but not limited to austenitic stainless steel, titanium, aluminum, or plastic.

The coil includes conductive leads (not shown) extending therefrom. The housing 134 further includes an opening (not shown) in the sidewall portion 151 through which a portion of each of the conductive leads extends or protrudes to an external side of the housing, which is where a terminal board 152 (e.g., a printed circuit board) may be located. In some examples, the conductive leads, or at least a portion of the conductive leads, may be electrically coupled with electrical pads 154 on the terminal board via a solder which also fixes the conductive leads relative to the terminal board.

In some embodiments, as illustrated in FIG. 2, the housing 134 further includes a sound tube or nozzle 156 (designated as 203 in FIGS. 7-11) acoustically coupled with the sound port 136. In some examples, the sound tube or nozzle extends longitudinally from the housing on an opposite side from the terminal board or the opening through which the conductive pins at least partially extend. In some examples, the sound tube or nozzle is located on some other side of the housing. In this example the sound tube is part of a sound tube structure, also referred to as a housing sleeve 158 that forms an acoustic seal for the front volume. The sound tube structure includes the sound tube 156 projecting from a first end thereof and a second end configured to receive at least a portion of a cup of the receiver and provides a sound path from the sound port. The sound tube structure includes a lid portion that covers a portion of the yoke lid 103 and that covers the coil. In some examples, the sound tube structure is glued to an outer surface of the coil and to an outer surface of the yoke lid.

In some implementations, each single BA can have a thickness less than 1mm and in some examples may be approximately 0.92mm. The armature in some implementations is approximately 0.15mm thick.

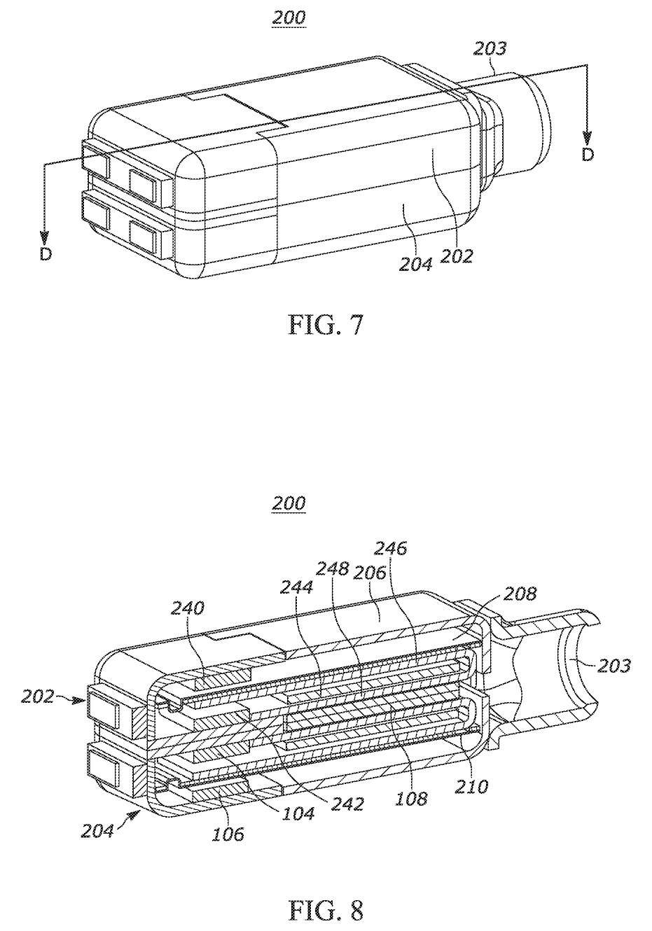

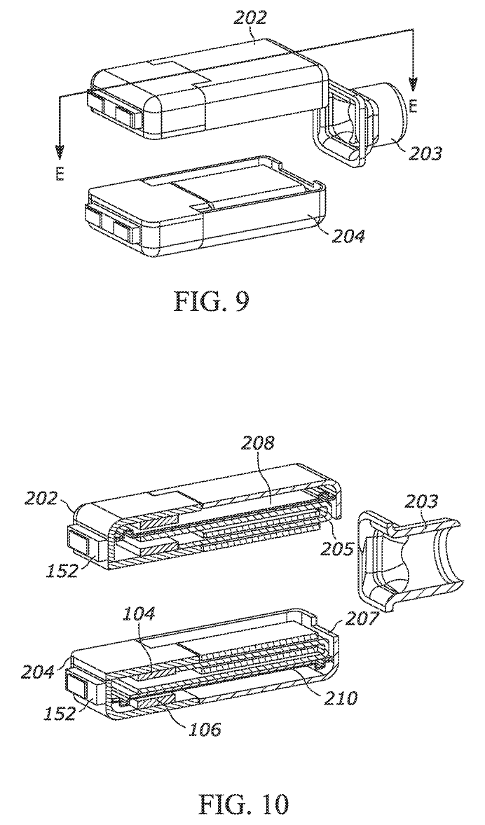

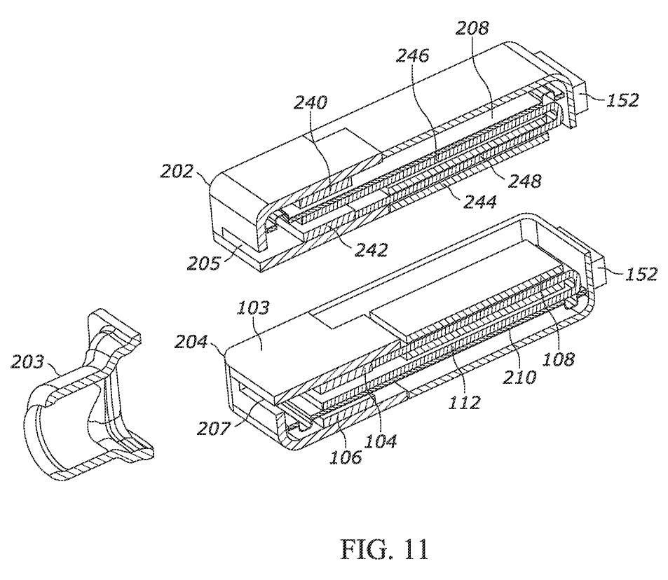

FIGS. 7-11 illustrate examples of dual balanced armature receivers that use multiple single balanced armature receivers of the same structure shown and described above, such as the example shown in FIGS. 4-6. FIG. 7 is a perspective view of a dual balanced armature receiver, FIG. 8 is a side sectional view of the balanced armature receiver along line D – D in FIG. 7, FIG. 9 is an expanded perspective view of the balanced armature receiver of FIGS. 7 and 10 is a side sectional view of the balanced armature receiver arrangement shown in FIG. 9. FIG. 11 illustrates a dual balanced armature receiver like the one in FIG. 7 except that the location of the sound port and external electrical contacts are flipped.

Referring to FIGS. 7-10, a balanced armature receiver 200 includes a first balanced armature receiver 202 and a second balanced armature receiver 204 each having the same structure as the receiver shown in FIG. 4 and includes a sound tube 203 acoustically coupled to the first sound port 205 and second sound port 207. The respective housings of each of the first and second balanced armature receivers comprise a respective cup each comprising a first cup portion and a second cup portion as described above, and wherein a respective yoke comprises a first wall of the first cup portion and an opposing wall of the first cup portion as described above.

The first BAR comprises a first housing having the first sound port, a first diaphragm 208 separates an interior of the first housing into a first back volume and a first front volume connected to the sound port of the first housing. A first yoke is disposed in the first housing, and retains first and second permanent magnets 240 and 242 in spaced-apart relation forming a first gap. A first coil 244 is located in the first front volume and has a first coil tunnel. The first armature 246 has a fixed portion 248 that extends through the first coil tunnel, and a movable portion that extends outside the first coil and comprises an end portion located at in the first gap between the first and second magnets. The end portion is free to deflect between the first and second magnets in response to an excitation signal applied to the first coil, and the first diaphragm mounted on the movable portion of the first armature and having a length that extends inside the first gap and over at least a portion of the first coil.

The second balanced armature receiver 204 is structurally the same as the first BAR but is inverted and positioned over the first BAR and acoustically and mechanically- coupled to the first balanced armature receiver 202. The second BAR comprises a second housing having the second sound port that is acoustically coupled to the first sound port. A second diaphragm 210 separates an interior of the second housing into a second back volume and a second front volume connected to the second port. A second yoke retains third and fourth permanent magnets in spaced-apart relation forming a second gap. A second coil has a second coil tunnel and a second armature has a fixed portion that extends through the second coil tunnel, and a movable portion that extends outside the second coil and comprising an end portion located at in the second gap between the third and fourth magnets, wherein the end portion is free to deflect between the third and fourth magnets in response to the excitation signal applied to the second coil. The second diaphragm is mounted on the movable portion of the second armature and has a length that extends inside the second gap and over at least a portion of the second coil. The first housing is aligned to be above the second housing and first front volume and the second from volumes are acoustically coupled.

In the example shown, the first front volume comprises the first coil, the movable portion of the first armature, the first magnet and the first back volume comprises the second magnet. The second front volume comprises the second coil, the movable portion of the second armature, the third magnet and the second back volume comprises the fourth magnet.

In this example, each of the first and second diaphragms are mounted to the movable portion of respective armatures with an adhesive on a surface of a respective diaphragm and the movable portion of the respective armature.

Referring to FIG. 11 the two BAR receivers 202 and 204 have a same structure as set forth as shown in FIG. 8 except that the respective sound ports 205 and 207 are located in the yoke housing portions and are adjacent to the magnets instead of adjacent to the coil as shown in FIG. 8. Also, the respective terminal boards 152 are located at ends opposing the sound ports and are located closer to respective coils than in FIG. 8.

Among other technical advantages, in some implementations, as shown, the thin BA design has an armature that has a stationary portion and movable portion separated by a curved portion, a coil is on the stationary part of the armature so that the diaphragm can be attached to the movable portion of the armature and maximize the diaphragm surface to extend the length of the coil and also the length of magnets. Also, in some implementations as shown, the diaphragm is directly attached to the armature to extend the diaphragm surface between the magnets and/or to eliminate a drive rod or link between the diaphragm and armature which makes the height of the housing smaller compared to BA designs that employ drive rods. Also, in some implementations as shown, the thin BA has an elongated coil in the front volume and a magnet in the front volume and the front volume extends beyond the coil. In some examples, the front volume extends the entire longitudinal length (along the long direction of the coil) of the interior of the housing and a back volume also extends the entire length of the interior of the housing and is free of the coil thereby providing a larger volume compared to the front volume. However, other suitable designs are contemplated. As shown in some implementations the housing cup houses two sides of the yoke that retain two magnets. With a single BA configuration, the housing cup houses the coil.

While the present disclosure and what is presently considered to be the best mode thereof has been described in a manner that establishes possession by the inventors and that enables those of ordinary skill in the art to make and use the same, it will be understood and appreciated that there are many equivalents to the exemplary embodiments disclosed herein and that myriad modifications and variations may be made thereto without departing from the scope and spirit of the disclosure, which is to be limited not by the exemplary embodiments but by the appended claims.

What is claimed is:

1. A balanced armature receiver comprising:
a housing having a sound port;
a diaphragm separating an interior of the housing into a back volume and a front volume connected to the sound port of the housing;
a yoke, disposed in the housing, retaining first and second permanent magnets in spaced-apart relation forming a gap;
a coil disposed in the front volume, having a coil tunnel;
an armature having a fixed portion that extends through the coil tunnel, and a movable portion that extends outside the coil and comprising an end portion located in the gap between the first and second permanent magnets, wherein the end portion is free to deflect between the magnets in response to an excitation signal applied to the coil; and
the diaphragm mounted on the movable portion of the armature and having a length that extends inside the gap and over at least a portion of the coil.

2. The balanced armature receiver of claim 1, wherein the housing comprises a cup that comprises a first cup portion and a second cup portion coupled to the first cup portion, and wherein the yoke comprises a first wall of the first cup portion and an opposing wall of the first cup portion.

3. The balanced armature receiver of claim 2, wherein the front volume comprises the coil, the movable portion of the armature, the first magnet and the back volume comprises the second magnet.

4. The balanced armature receiver of claim 3 wherein the diaphragm is configured to have a longitudinal length that extends past a full length of the coil and past a full length of the first and second magnets.

5. The balanced armature receiver of claim 3 wherein the diaphragm comprises a perimeter portion, the perimeter portion affixed to a side wall of the housing.

6. The balanced armature receiver of claim 1, wherein the diaphragm comprises a movable portion, the movable portion of the diaphragm directly affixed to the movable portion of the armature with an adhesive.

7. The balanced armature receiver of claim 1 comprising adhesive in a tunnel of the coil, the adhesive also in contact with the fixed portion of the armature.

8. The balanced armature receiver of claim 2 wherein the first cup portion is comprised of magnetic flux conducting material and the second cup portion is comprised of non-magnetic flux conducting material and the second cup portion comprises the sound port and is configured to house the coil.

9. The balanced armature receiver of claim 3 comprising a sound tube structure comprising a sound tube projecting from a first end thereof and a second end configured to receive at least a portion of the cup and provide a sound path from the sound port, the sound tube structure further comprising a lid portion that provides an acoustic seal for the front volume.

10. A balanced armature receiver comprising:
a first balanced armature receiver comprising:
a first housing having a first sound port;
a first diaphragm separating an interior of the first housing into a first back volume and a first front volume connected to a sound port of the first housing;
a first yoke, disposed in the first housing, retaining first and second permanent magnets in spaced-apart relation forming a first gap;
a first coil in the first front volume having a first coil tunnel;
the first armature having a fixed portion that extends through the first coil tunnel, and a movable portion that extends outside the first coil and comprising an end portion located at in the first gap between the first and second magnets, wherein the end portion is free to deflect between the first and second magnets in response to an excitation signal applied to the first coil; and
the first diaphragm mounted on the movable portion of the first armature and having a length that extends inside the first gap and over at least a portion of the first coil; and
a second balanced armature receiver, acoustically coupled to the first balanced armature receiver, comprising:
a second housing having a second sound port that is acoustically coupled to the first sound port;
a second diaphragm separating an interior of the second housing into a second back volume and the second front volume connected to a second port;
a second yoke retaining third and fourth permanent magnets in spaced-apart relation forming a second gap;
a second coil having a second coil tunnel;
a second armature having a fixed portion that extends through the second coil tunnel, and a movable portion that extends outside the second coil and comprising an end portion located at in the second gap between the third and fourth magnets, wherein the end portion is free to deflect between the third and fourth magnets in response to the excitation signal applied to the second coil; and
the second diaphragm mounted on the movable portion of the second armature and having a length that extends inside the second gap and over at least a portion of the second coil.

11. The balanced armature receiver of claim 10 wherein the first housing is aligned to be above the second housing and wherein first front volume and the second from volumes are acoustically coupled.

12. The balanced armature receiver of claim 11 comprising a sound tube acoustically coupled to the first and second sound ports and wherein respective housings of each of the first and second balanced armature receivers comprise a respective cup each comprising a first cup portion and a second cup portion, and wherein a respective yoke comprises a first wall of the first cup portion and an opposing wall of the first cup portion.

13. The balanced armature receiver of claim 12 wherein the first front volume comprises the first coil, the movable portion of the first armature, the first magnet and the first back volume comprises the second magnet, and wherein the second front volume comprises the second coil, the movable portion of the second armature, the third magnet and the second back volume comprises the fourth magnet.

14. The balanced armature receiver of claim 13 wherein the diaphragm is configured to have a longitudinal length that extends past a full length of the coil and past a full length of the first and second magnets.

15. The balanced armature receiver of claim 12 wherein each of first and second diaphragm is a ring shaped diaphragm and each diaphragm comprises a perimeter surface glued to a side wall of a respective housing.

16. The balanced armature receiver of claim 10, wherein each of the first and second diaphragms are mounted to the movable portion of respective armatures with an adhesive on a surface of a respective diaphragm and the movable portion of the respective armature.

17. The balanced armature receiver of claim 10 comprising 1 comprising an adhesive in a tunnel of each of the first and second coils, the adhesive also in contact with the fixed portion of a respective armature.

18. The balanced armature receiver of claim 13 comprising a sound tube structure comprising a sound tube projecting from a first end thereof and a second end configured to provide a sound path from the first and second sound ports.
